(19) United States
(12) Patent Application Publication
(10) Pub. No.: US 2009/0307389 A1
(43) Pub. Date: Dec. 10, 2009

(54) SWITCHABLE ACCESS STATES FOR NON-VOLATILE STORAGE DEVICES

(75) Inventors: Steven Sprouse, San Jose, CA (US); Henry Hutton, Tracy, CA (US); Dhaval Parikh, Santa Clara, CA (US)

Correspondence Address: BEYER LAW GROUP LLP/ SANDISK, P.O. BOX 1687, CUPERTINO, CA, 95015-1687, US

(73) Assignee: SANDISK CORPORATION, Milpitas, CA (US)

(21) Appl. No.: 12/136,672

(22) Filed: Jun. 10, 2008

(51) Int. Cl. G06F 3/00

(52) U.S. Cl. 710/36

(57) ABSTRACT

Techniques for switching access states for accessing non-volatile are disclosed. A plurality of non-volatile memory portions can be effectively presented as: (a) a single logical unit in a first access state (“single unit access state”) and (b) as multiple logical units in a second access state (“multi-unit access state”). An access switching system can be provided for a device that includes a plurality of non-volatile storage portions. As a result, the device can be operable to effectively switch between the first and second access states. In the first access state, the plurality of non-volatile storage portions can be effectively presented as a single logical unit for access by another device, thereby allowing the other device to effectively access the plurality of non-volatile storage portions from a single access point. However, the device can also be operable to switch to a second access state in which the plurality of the non-volatile storage portions can be effectively presented to the other device as multiple logical units, thereby allowing the other device to access the plurality of non-volatile storage portions individually by using multiple access points respectively associated with the multiple logical units presented to the other device.

### BACKGROUND OF THE INVENTION

Conceptually, a computing system (e.g., a computing device, a personal computer, a laptop, a Smartphone, a mobile phone) can accept information (content or data) and manipulate it to obtain or determine a result based on a sequence of instructions (or a computer program) that effectively describes how to process the information. Typically, the information used by a computing system is stored in a in a computer readable memory using a digital or binary form. More complex computing systems can store content including the computer program itself. A computer program may be invariable and/or built into, for example a computer (or computing) device as logic circuitry provided on microprocessors or computer chips. Today, general purpose computers can have both kinds of programming. A computing system can also have a support system which, among other things, manages various resources (e.g., memory, peripheral devices) and services (e.g., basic functions such as opening files) and allows the resources to be shared among multiple programs. One such support system is generally known and an Operating System (OS) which provides programmers with an interface used to access these resources and services.

Given the prevalence of computing devices in modern society, computer storage or computer memory used to store content, is often casually referred to as “memory.” Storing content (or information retention) is of one the core functions of computing devices. As such, memory is one of the fundamental components of all modern computers and is often coupled with a Central Processing Unit (CPU) to implement the basic Von Neumann computer model which has been used since the 1940s.

Today, numerous types of computing devices are available. These computing devices widely range with respect to size, cost, amount of storage and processing power, from the expensive and powerful servers, relatively cheaper Personal Computers (PC's) and laptops, to more inexpensive microprocessors or computer chips provided in storage devices, automobiles, and household electronic appliances.

In recent years, computing systems have become more portable and mobile. As a result, various mobile and handheld devices have been made available. By way of example, wireless phones, media players, Personal Digital Assistants (PDA's) are widely used today. Generally, a mobile or a handheld device (also known as handheld computer or simply handheld) can be a pocket-sized computing device, typically utilizing a small visual display screen for user output and a miniaturized keyboard for user input. In the case of a Personal Digital Assistant (PDA), the input and output can be combined into a touch-screen interface.

As suggested above, memory and memory devices have been an important part of computing and computing devices. Memory technology has markedly improved in recent years. Today, relatively large amount of content can be stored n a portable and easy to access devices such as USB flash drives (or USB flash devices). The content stored on USB flash drive can be easily carried and copied on various computing devices. By way of example, data stored on server computer can be copied on a USB flash drive and taken home and loaded (or copied) on a Personal Computer (PC) and used. The data can be modified on the PC and stored back on the USB flash drive. The USB flash drive can be taken back to work to be used by a computer provided at work or carried to a different city and used by another computer or laptop. The USB flash drive is especially popular today and represents an exemplary advancement in storage technology which has effectively improved portability and mobility of computing systems. As such, USB flash drives will be discussed below.

USB flash drives are generally NAND-type flash memory data storage devices integrated with a USB (universal serial bus) interface. NAND flash architecture was introduced by Toshiba in 1989. NAND flash memories are typically accessed much like block devices such as hard disks or memory cards. The pages are typically 512 or 2,048 bytes in size. Associated with each page are a few bytes (typically 12-16 bytes) that should be used for storage of an error detection and correction checksum. USB flash drives are typically small, lightweight, removable and rewritable. Memory capacities for USB flash Drives currently can range from 32 megabytes up to 64 gigabytes. Capacity is limited only by current flash memory densities, although cost per megabyte may increase rapidly at higher capacities due to the expensive components. USB flash drives offer potential advantages over other portable storage devices, particularly the floppy disk. They are more compact, generally faster, hold more data, and are more reliable (due to both their lack of moving parts, and their more durable design) than floppy disks. These types of drives use the USB mass storage standard, supported natively by modern operating systems such as Windows, Mac OS X, Linux, and Unix.

Generally, a flash drive has a small printed circuit board typically in a plastic or metal casing, making the drive sturdy enough to be carried about in a pocket, as a key fob, or on a lanyard. The USB connector protrudes from the casing, and is usually covered by a removable cap. Most flash drives use a standard type-A USB connection allowing them to be connected directly to a port on a personal computer.

To access the data stored in a flash drive, the drive is typically connected to a computer, either by plugging it into a USB host controller built into the computer, or into a USB hub. Typically, flash drives are active only when plugged into a USB connection and draw all necessary power from the supply provided by that connection. However, some flash drives, especially high-speed drives, may require more power than the limited amount provided by a bus-powered USB hub, such as those built into some computer keyboards or monitors. These drives will not work unless plugged directly into a host controller (i.e., the ports found on the computer itself) or a self-powered hub.

The advancement in memory devices and mobile computing is generally appreciated by those skilled in the art as well as the general public. As such, improved techniques for accessing stored content would be useful.

### SUMMARY OF THE INVENTION

Broadly speaking, the invention relates to storage systems for computing (or computer) environments. More particularly, the invention relates to non-volatile storage systems and devices for which techniques for switching access states are disclosed.

In accordance with one aspect of the invention, a plurality of non-volatile memory portions can be effectively presented as (a) a single logical unit in a first access state (“single unit access state”) and (b) as multiple logical units in a second access state (“multi-unit access state”).

In one embodiment, an access switching system is provided for a device that includes a plurality of non-volatile storage portions. As a result, the device is operable to effectively switch between first and second access states. In the first access state, the plurality of non-volatile storage portions can be effectively presented as a single logical unit for access by another device, thereby allowing the other device to effectively access the plurality of non-volatile storage portions from a single access point. However, the device is operable to switch to a second access state in which the plurality of the non-volatile storage portions can be effectively presented to the other device as multiple logical units, thereby allowing the other device to access the plurality of non-volatile storage portions individually by using multiple access points respectively associated with the multiple logical units presented.

In accordance with another embodiment, a device can include a plurality of controllers including first and second controllers for effectively controlling access to first and second non-volatile storage portions. The device is operable to effectively provide the first and second non-volatile storage portions in a first access state in which an access point is effectively provided as a single access for accessing both of the first and second non-volatile storage portions. The single access point is operable to effectively forward commands for accessing any one of the first and second non-volatile storage portions directly and/or indirectly to the first controller or second controller so that any of the first and second non-volatile storage portions can be made accessible via the single access point. As a result, the first and second non-volatile storage portions can be accessed by another device which can issue access commands via the single access point in order to access the first and second non-volatile storage portions effectively as a single logical unit. It will be appreciated that the device can be further operable to effectively provide the plurality of non-volatile storage portions as two or more logical units when the device is in a second access state in which the first non-volatile storage portion can be directly accessed via the first controller and the second non-volatile storage portion can be directly accessed via the second controller. As a result, each one of the plurality of non-volatile storage portions can be accessed individually as a single logical unit.

In accordance with yet another embodiment, an access state switching system can includes a hub and/or switch system connected to a plurality of controllers and operable to effectively allow the controllers to be connected to a single access point in a manner that access commands can be effectively forwarded to each one of the controllers so that each one of a plurality non-volatile memory portions controlled by the controllers can be accessed via the single access point when the plurality of controllers are presented in a single unit state access state as one logical unit. It will be appreciated that the hub and/or switch system can, for example, include a plurality of hub and/or switch components respectively connected to each one of the controllers in a “daisy chain” configuration. As another example, the hub system and/or switch system can includes an external switch and/or hub component provided as an external component with respect to the controllers. It will also be appreciated that one or more hub and/or switch component can be effectively integrated with one or more controllers. In addition, a controller can act as a master controller component with integrated hub/switch functionality or an external hub/hub/switch system can be provided for a master controller with acts as a master to one or more slave controllers.

The invention can be implemented in numerous ways, including, for example, a method, an apparatus, a device, a storage device, and a computer readable medium, and a computing system (e.g., a computing device). Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIGS. 1A and 1B depict a device in accordance with one embodiment of the invention.

FIG. 1C depicts a method for providing access to non-volatile storage in accordance with one embodiment of the invention

FIGS. 2A and 2B depict a device in accordance with another embodiment of the invention.

FIG. 2C depicts the non-volatile storage portion in accordance with another embodiment of the invention.

FIG. 3A depicts an access state switching system provided for a device 302 in accordance with one embodiment of the invention.

FIG. 3B depicts an access state switching system in a multi-unit access state in accordance with one embodiment of the invention.

FIG. 3C depicts a method for providing access to a device in accordance with one embodiment of the invention.

FIG. 4A depicts an access state switching system in accordance with another embodiment of the invention.

FIG. 4B depicts an external hub and/or switching system in a disable hub/switch mode in accordance with another embodiment of the invention.

FIG. 5A depicts a device in accordance with another embodiment of the invention.

FIG. 5B depicts a configuration of a master component (or device) and slave components in a multi-unit access state in accordance with one embodiment of the invention.

FIG. 6A depicts a device in accordance with yet another embodiment of the invention.

FIG. 6B depicts the configuration of the integrated master controller 406a and the hub and/or switch system.

FIGS. 7A and 7B depict exemplary configuration of connectors in accordance with various embodiments of the invention.

### DETAILED DESCRIPTION OF THE INVENTION

As noted in the background section, advancement in storage (or memory) technology has further facilitated the use of modern and mobile storage devices where content can be stored and easily carried for use on various computing devices. Today, various non-volatile storage devices (e.g., USB flash drives, flash cards) are generally available to the public. A number of non-volatile storage devices available today can be connected together or effectively integrated in various configurations to form a single device. However, conventionally, such configurations of non-volatile storage devices are made accessible either as a single unit (or device) or as multiple units (or devices). By way of example, two (2) individual USB flash drives each providing one (1) Giga Bytes of flash memory can be directly connected to a computer and appear as two separate devices to the computer (e.g., two devices on drives “E:” and “F:” of a Personal Computer). The same two (2) USB flash drives can be connected via a USB hub to the computer. The USB hub can additional provide a “device merge” or “device concatenation” functionality to effectively merge the two USB flash drives and present them as a single drive. As a result, the two individual USB flash drives can be presented as a single device and made accessible via the USB hub to the computer (e.g., a device on drive “E:” of a Personal Computer).

It will be appreciated that a non-volatile storage device that can switch its access state between single and multiple units would be highly useful. The capability to switch the access state, among other things, would allow a non-volatile storage device to be presented and accessed as a single logical unit in a one situation and as multiple logical units in another situation. By way of example, when a non-volatile storage device is connected to a Personal Computer (PC) at home, it would present a single logical unit for access by the Personal Computer. In this situation, a user would see the non-volatile device as a single device on a particular drive (e.g., drive “E”) and the Personal Computer would effectively access the non-volatile storage device as a single device with a single logical unit. However, when the same non-volatile storage device is connected to a host device with relatively large throughput capabilities (e.g., a host in a kiosk application), the non-volatile storage device would be able to present multiple logical units to the host device. This allows multiple access operations (e.g., writes) to be performed independently and in parallel. In the situation, the host device could effectively access the non-volatile storage device as it were multiple devices using multiple logical units provided for access.

As such, it will be appreciated that the invention provides techniques for switching access states for accessing non-volatile memory. In accordance with one aspect of the invention, a plurality of non-volatile memory portions can be effectively presented as (a) a single logical unit in a first access state (“single unit access state”) and (b) as multiple logical units in a second access state (“multi-unit access state”).

In one embodiment, an access switching system is provided for device that includes a plurality of non-volatile storage portions. As a result, the device is operable to effectively switch between first and second access states. In the first access state, the plurality of non-volatile storage portions can be effectively presented as a single logical unit for access by another device, thereby allowing the other device to effectively access the plurality of non-volatile storage portions from a single access point. However, the device is operable to switch to a second access state in which the plurality of the non-volatile storage portions can be effectively presented to the other device as multiple logical units, thereby allowing the other device to access the plurality of non-volatile storage portions individually by using multiple access points respectively associated with the multiple logical units presented.

In accordance with another embodiment, a device can include a plurality of controllers including first and second controllers for effectively controlling access to first and second non-volatile storage portions. The device is operable to effectively provide the first and second non-volatile storage portions in a first access state in which an access point is effectively provided as a single access for accessing both of the first and second non-volatile storage portions. The single access point is operable to effectively forward commands for accessing any one of the first and second non-volatile storage portions directly and/or indirectly to the first controller or second controller so that any of the first and second non-volatile storage portions can be made accessible via the single access point. As a result, the first and second non-volatile storage portions can be accessed by another device which can issue access commands via the single access point in order to access the first and second non-volatile storage portions effectively as a single logical unit. It will be appreciated that the device can be further operable to effectively provide the plurality of non-volatile storage portions as two or more logical units when the device is in a second access state in which the first non-volatile storage portion can be directly accessed via the first controller and the second non-volatile storage portion can be directly accessed via the second controller. As a result, each one of the plurality of non-volatile storage portions can be accessed individually as a single logical unit.

In accordance with yet another embodiment, an access state switching system can includes a hub and/or switch system connected to a plurality of controllers and operable to effectively allow the controllers to be connected to a single access point in a manner that access commands can be effectively forwarded to each one of the controllers so that each one of a plurality non-volatile memory portions controlled by the controllers can be accessed via the single access point when the plurality of controllers are presented in a single unit state access state as one logical unit. It will be appreciated that the hub and/or switch system can, for example, include a plurality of hub and/or switch components respectively connected to each one of the controllers in a “daisy chain” configuration. As another example, the hub system and/or switch system can includes an external switch and/or hub component provided as an external component with respect to the controllers. It will also be appreciated that one or more hub and/or switch component can be effectively integrated with one or more controllers. In addition, a controller can act as a master controller component with integrated hub/switch functionality or an external hub/hub/switch system can be provided for a master controller with acts as a master to one or more slave controllers.

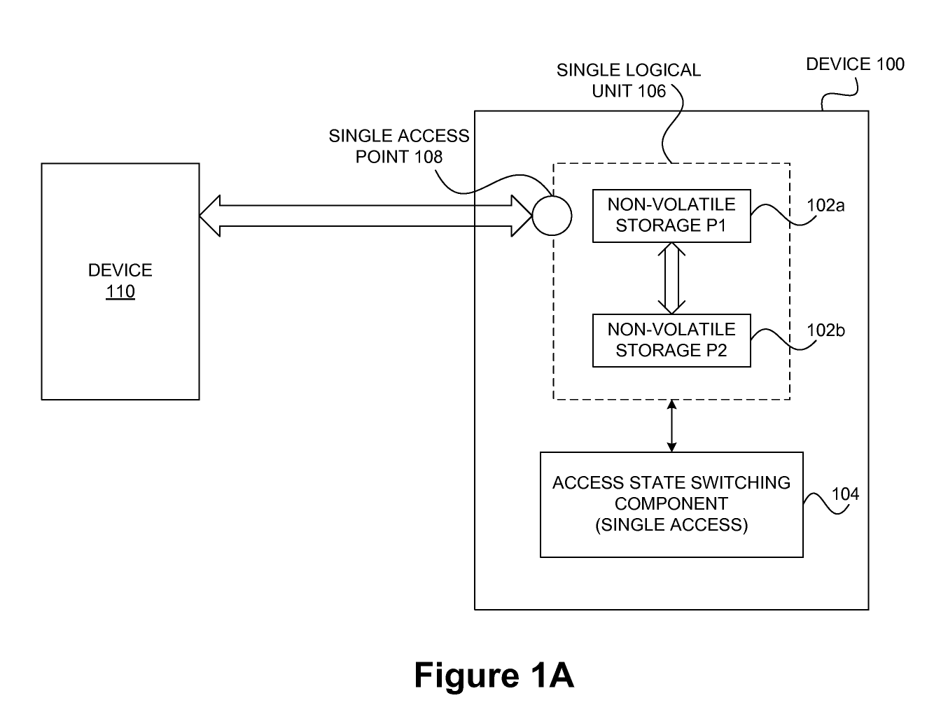

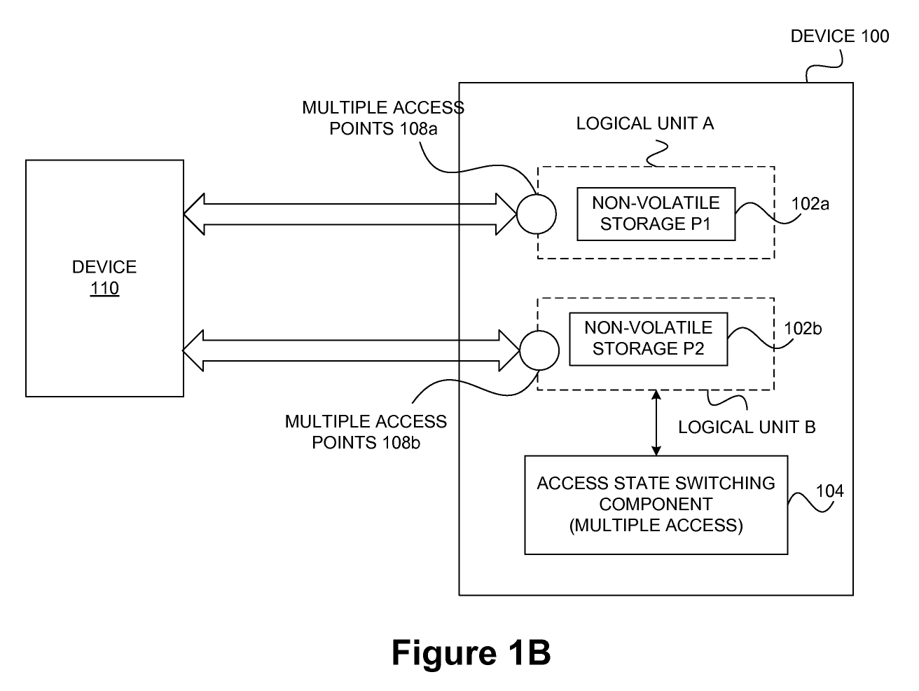

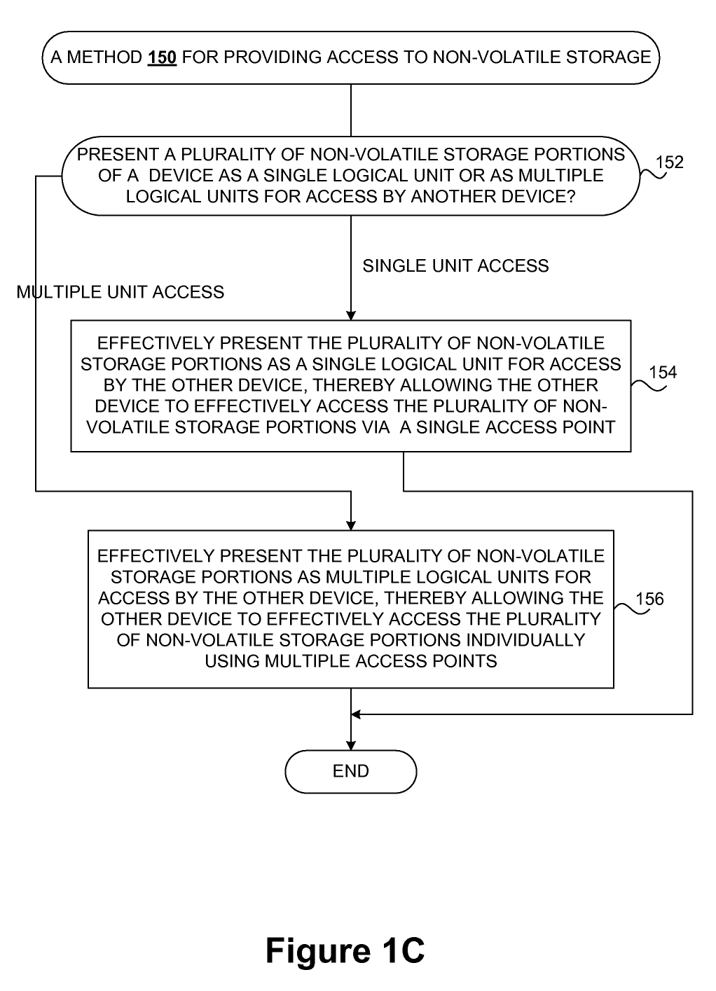

Embodiments of these aspects of the invention are discussed below with reference to FIGS. 1A-7B. However, those skilled in the art will readily appreciate that the detailed description given herein with respect to these figures is for explanatory purposes as the invention extends beyond these limited embodiments.

FIGS. 1A and 1B depict a device 100 in accordance with one embodiment of the invention. Referring to FIG. 1A, the device 100 includes a plurality of non-volatile storage portions P1 and P2 (102a and 102b). The device 100 can, for example, be a non-volatile storage device provided for storing data for a computing system in a computing environment (not shown). As such, the device 100 can, for example, be a USB flash drive provided in accordance with the invention. It will be appreciated that the device 100 is operable to provide at least two access states. More particularly, an access state switching component (or system) 104 can effectively present the plurality of non-volatile storage portions P1 and P2 (102a and 102b) as a single logical unit 106 when the device 100 is in a first access state (single unit access state). As a result, a device 110 can effectively access the plurality of non-volatile storage portions P1 and P2 (102a and 102b) via a single access point 108, as the logical unit 106. Moreover, the access state switching component 104 can effectively switch the state of access from the single unit access state where the plurality of non-volatile storage portions P1 and P2 (102a and 102b) are represented as one logical unit 106, to a multi-access state where multiple logical units and access points are effectively presented to the device 110 by the device 100.

To further elaborate, FIG. 1B depicts the device 100 in a multi-access state where the access state switching component 104 has effectively switched the access unit of the device 100 from the single access state depicted in FIG. 1B to a multi-access state where multiple access points 108a and 108b are provided for access by the device 110. In other words, each of the non-volatile storage portions P1 and P2 are respectively presented in effect as an individual logical unit, namely, logical units A and B depicted in FIG. 1B.

FIG. 1C depicts a method 150 for providing access to non-volatile storage in accordance with one embodiment of the invention. The method 150 can, for example, be performed by the device 100 depicted in FIGS. 1A and 1B. Referring now to FIG. 1C, initially, it is determined (152) whether to effectively present a plurality of non-volatile storage portions provided by a device as a single logical unit or as multiple logical units for access by another device. Typically, access to each one of the plurality of non-volatile storage portions is effectively controlled by the device itself (e.g., access to a non-volatile storage portion is controlled by a controller effectively provided by the device). The determination (152) of whether to present a plurality of a device as a single logical unit or as multiple logical units is typically performed when another device is operatively connected to the device for accessing one or more of the plurality of non-volatile storage portions. If it is determined (152) to effectively present the plurality of non-volatile storage portions as a single logical unit, the plurality of non-volatile storage portions are effectively presented (154) as a single logical unit for access by the other device, thereby allowing the other device to effectively access the plurality of non-volatile storage portions via a single access point. Typically, the single access point (e.g., a port) is effectively provided for access by the other device when the other device is operatively connected to the device. On the other hand, if it is determined (154) to effectively present the plurality of non-volatile storage portions as multiple logical units, the plurality of non-volatile storage portions are effectively presented (156) as multiple logical units for access by the other device, thereby allowing the other device to access the plurality of non-volatile storage portions individually using multiple access points respectively associated with the multiple logical units. Typically, each logical unit is accessible via its own individual access point (e.g., a port). The method 150 ends following either the presentation of the plurality of non-volatile storage portions as a single logical unit (154) or as multiple logical units (156).

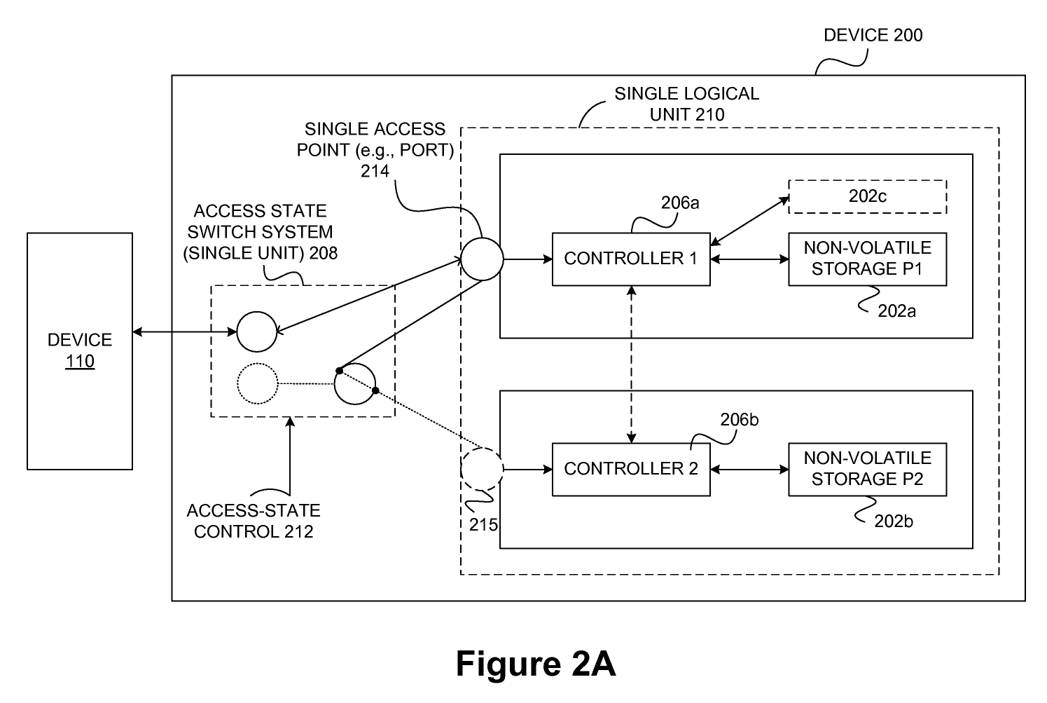

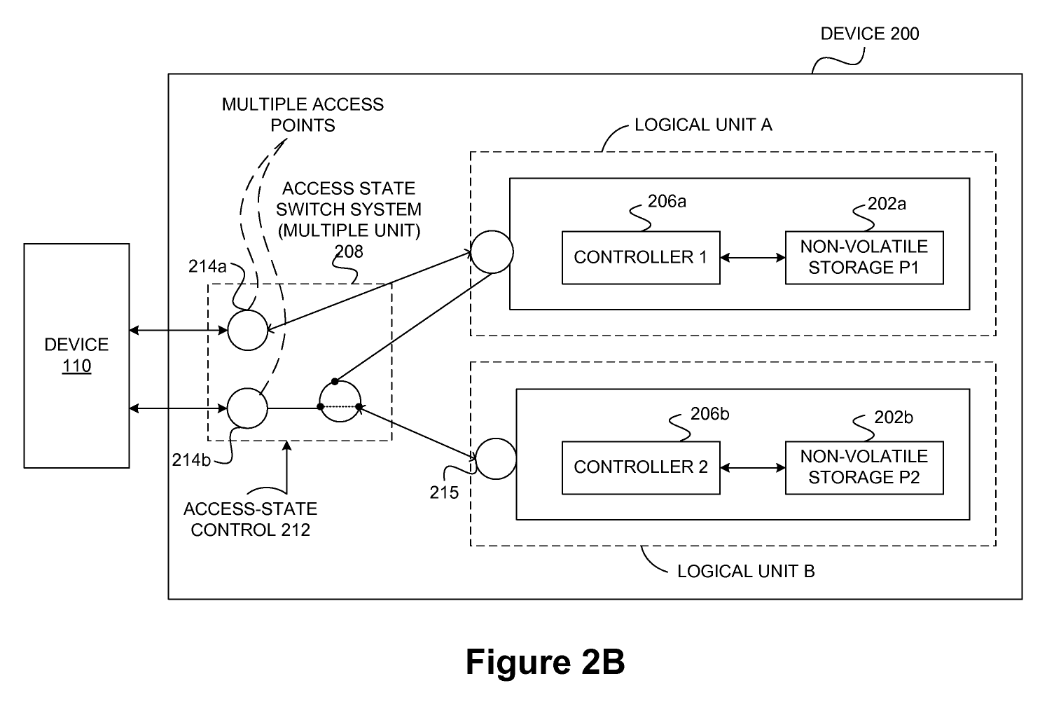

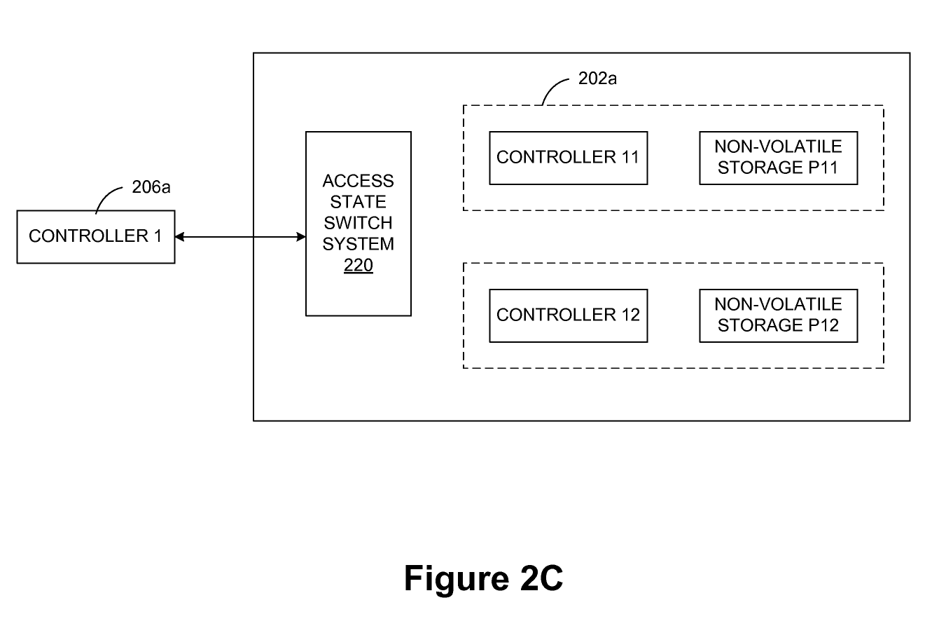

FIGS. 2A and 2B depict a device 200 in accordance with another embodiment of the invention. Referring to FIG. 2A, the device 200 includes a plurality of non-volatile storage portions 202 including non-volatile storage portions P1 and P2 (102a and 102b). In addition, a plurality of controllers 206 are operable to effectively control access to at least one of the non-volatile storage portions 202. Referring to FIG. 2A, a controller 206a is operable to effectively control access to non-volatile storage portions 202a and possibly one or more other non-volatile storage portions (e.g., 202c). Typically, the controller 206a is provided to control access to at least one non-volatile storage portion 202 (e.g., non-volatile storage portion 202a), but cannot control access to at least another non-volatile storage portion (e.g., 202b). As such, the first controller 206a can, for example, be operable to effectively control access only to non-volatile storage portion 202a, and a second controller 206b can be operable to control access to a second non-volatile storage portion 202b.

Referring to FIG. 2A, an access state switch system 208 is depicted in a single unit access state (or open switch state) where the plurality of controllers 206 and non-volatile storage portions 202 are effectively represented as one logical unit 210 to a device 110 which is operatively connected for accessing one or more of the non-volatile storage portions 202. In other words, access state switch system 208 can effectively provide a single access point (e.g., a port) 214 for accessing the plurality of non-volatile storage portions 202.

It will be appreciated that the single access point 214 can, for example, be configured to effectively forward access commands for accessing any one of the first and second non-volatile storage portions 202a and 202b directly and/or indirectly to first and second controllers 206a and 206b so that any one the first and second non-volatile storage portions 202a and 202b can be effectively accessed by at least one other device 110. This means that the device 110 can issue said access command via the single access point 214. As a result, device 110 can access both the first and second non-volatile storage portions 202a and 202b as a single logical unit despite the fact that they may be effectively controlled by different controllers (controllers 206a and 206b).

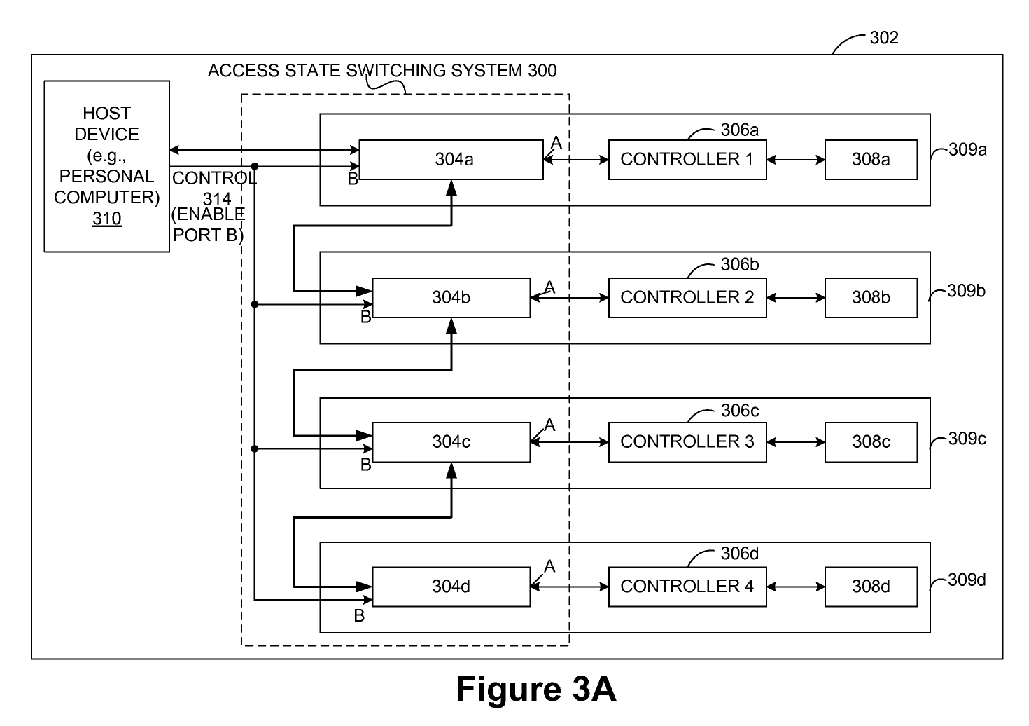

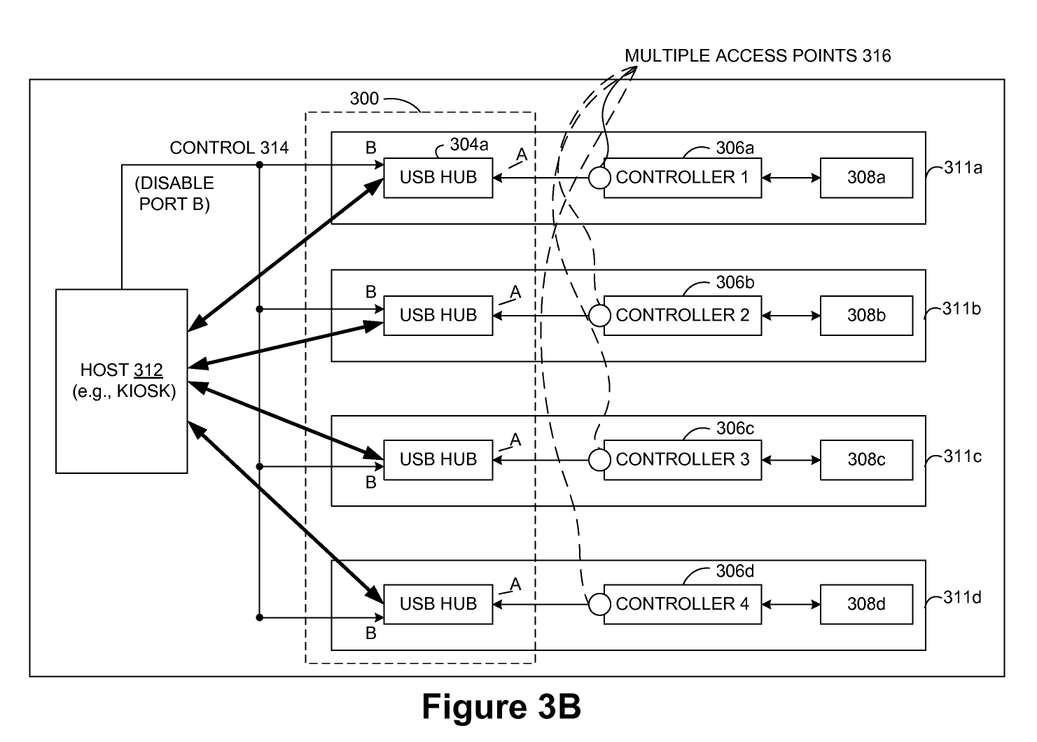

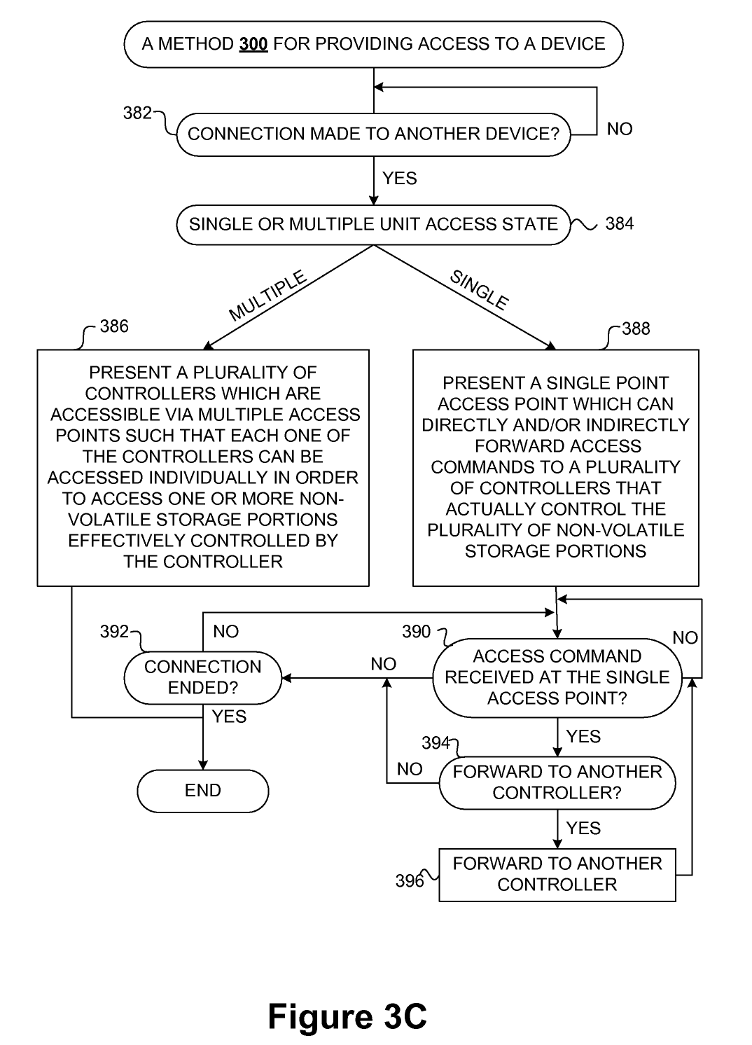

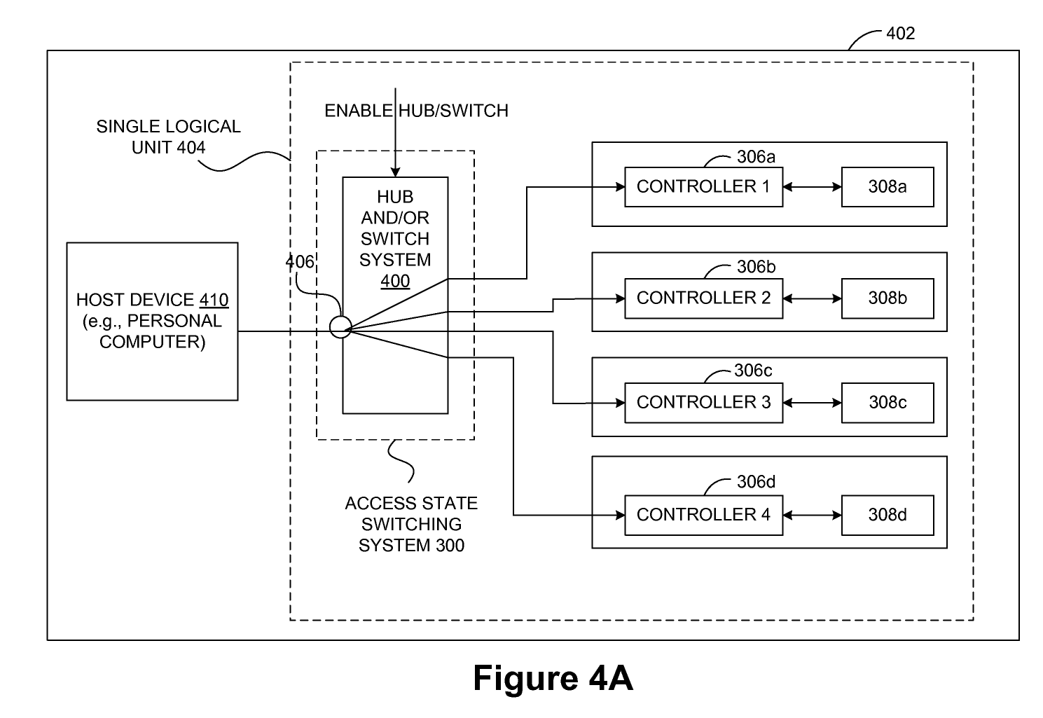

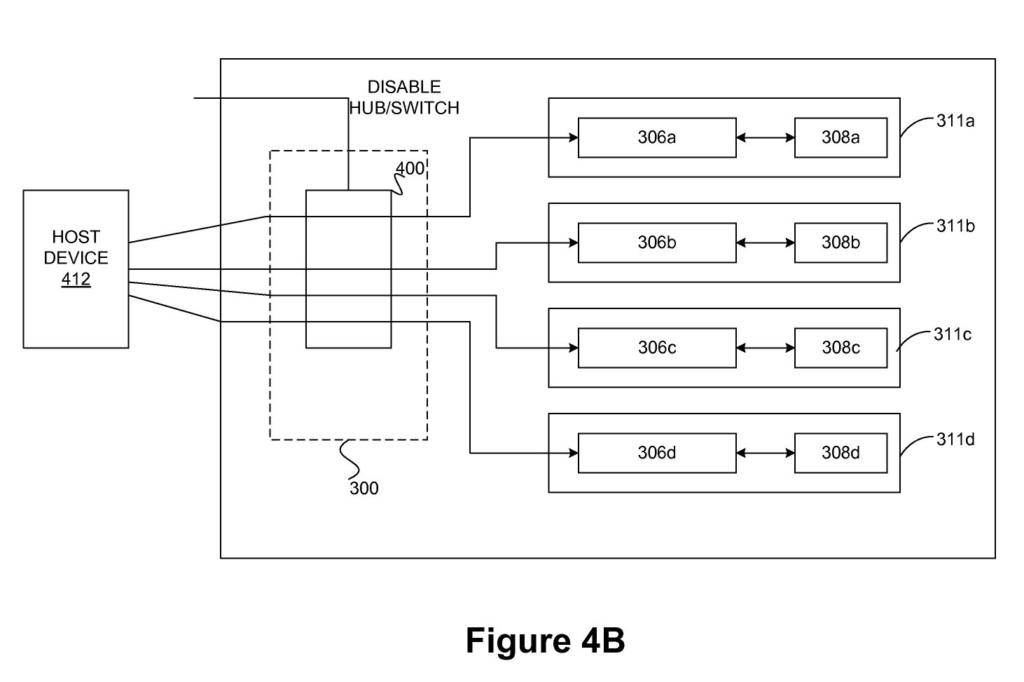

As shown in FIG. 2A, the single access point 214 can be configured and/or operable to effectively forward access commands directly to the controller 206a and 206b. Such a configuration is depicted in greater detail in FIG. 3A in accordance with one embodiment of the invention. However, referring back to FIG. 2A, it should be noted that the single access point 214 can be configured and/or operable to effectively forward access commands to one or more access components 215 which are configured and/or operable to effectively provide the access commands to the appropriate controller. By way of example, access commands for accessing the non-volatile storage portion P2 (202 b) can be received at the single access point 214 and forwarded to an access component 215 which effectively provides the access commands to the second controller 206b, thereby effectively connecting the first and second controllers 206a and 206b to said single access point. Such a configuration is depicted in greater detail in FIG. 4A in accordance with one embodiment of the invention.

It should be noted that the access state switch system 208 can be configured and/or operable to receive an access state control 212 that effectively determines the state of access for the device 200. As a result, the access state control 212 can effectively switch the state access from the single unit state of access depicted in FIG. 2A to a multi-state access state depicted in FIG. 2B.

Referring now to FIG. 2B, the access state switch system 208 is depicted in a multi-unit state where multiple access points 214a and 214b are effectively provided to the device 110 for accessing the plurality of non-volatile storage portions 202a and 202b, as individual logical units A and B. As a result, the first non-volatile storage portion P1 (202a) can be made accessible via the first access point 214a. Similarly, the second non-volatile storage portion P2 (202b) can be made accessible via the second access point 214b. This means that the device 110 can access each of the non-volatile storage portions 202 individually and perform various access operations by effectively interfacing with each one of the controllers 206a and 206b individually, and/or separately. It will be appreciated that these access operations can, for example, include parallel write operations to effectively write data to the non-volatile storage portions 202a and 202b in parallel. As such, the embodiment depicted in FIG. 2B is especially useful when relatively high write output is desired (e.g., a kiosk application where the device 110 can provide relatively large amount of data rates to write data to the device).

As noted above, the access state control 212 can effectively switch the access states of the device 200 between single and multiple access states depicted in FIGS. 2A and 2B.

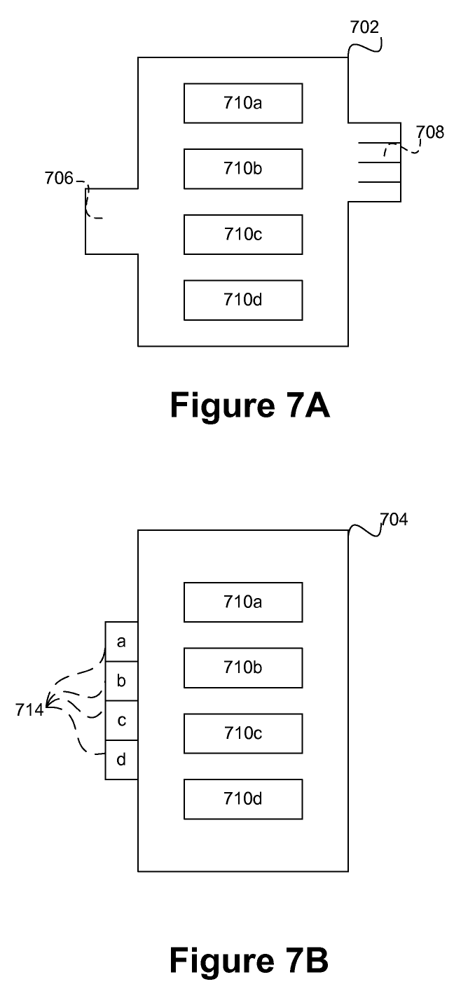

The access state control 212 can, for example, be a signal which is effectively obtained by the access state switch system 208. As such, the device 110, for example, be operable to receive the access state control 212 as signal when the device 110 is operatively is connected to the device 200. By way of example, the device 110 can effectively provide a signal to the device 200 in order to indicate the access state required and/or preferred by the device 110 for accessing the non-volatile storage portions 202. As another example, the access state control 212 can be provided as an input effectively serving as a configuration option for the device 200 (e.g., an option allowing a user to switch between different access states). As yet another example, the type of the connection which is made between the device 110 and device 200 can effectively indicate and/or determine the access state control 212 which in turn effectively determines the access state for accessing the non-volatile storage portions 202. By way of example, two different connectors can be provided for the device 200, whereby connecting via the first connector would effectively result in placing the device 200 in a single unit access state, whereas making a connection via the second connector would effectively place the device 200 in a multi-unit access state. Exemplary configurations of connectors are depicted in FIGS. 7A and 7B in accordance with various embodiments of the invention. Those skilled in the art will also appreciate that the access state switch system 208 can, for example, be provided as a hub and/or switch mechanism (e.g., an USB hub and/or switch).

It should be noted that each of the non-volatile storage portions depicted in FIGS. 2A and 2B can effectively be replaced by a non-volatile storage device providing an access state switch system in accordance to the invention. To further elaborate, FIG. 2C depicts the non-volatile storage portion P1 (202a, also shown in FIGS. 2A and 2B) effectively provide with a plurality of controllers and access state switching subsystem 220 which effectively allows the non-volatile storage portion 202a to switch between single and multiple unit access states in a similar manner as discussed with respect to the device 200 depicted in FIGS. 2A and 2B. As such, it will be appreciated that the device 200 can effectively include one or more access state switching systems (or subsystems) to allow one or more storage portions (or sub-portions) to selectively be provided as one or multiple logical units.

As noted above, an access state switching system can effectively switch between single and multiple access states in accordance with one aspect of the invention. To further elaborate, FIG. 3A depicts an access state switching system 300 provided for a device 302 in accordance with one embodiment of the invention. Referring to FIG. 3A, the access state switching system 300 includes a hub/switch system provided by hub/switch components 304. As depicted in FIG. 3A, each individual hub/switch components 304 is effectively provided for one of the controllers 306. By way of example, the hub/switch component 304a is effectively provided for the controller 306a which effectively controls access to a non-volatile storage portion 308a. Referring back to FIG. 3A, those skilled in the art will appreciate that the hub/switch components 304 are in a “daisy chain” configuration where each individual hub/switch component 304 is operable to receive a control signal 314 which is effectively used to turn on the hub and/or switch functionality provided by the access switching system in the embodiment depicted in FIG. 3A. By way of example, providing an enable port B control signal effectively enables port B of each of the hub/switch components 304. As a result, the hub/switch functionality provided by the access state switching system 300 can be enabled to effectively represent the plurality of the non-volatile storage portions 308 as a single logical unit to a host device 310. This means that the host device 310 can be effectively connected via a connection 312 to the hub/switch component 304a, and use it as a single access point for accessing any of the non-volatile storage portions 308a, 308b, 308c and 308d. By way of example, each one of the hub/switch components 304 can be provided as a USB hub/switch component such that, for example, a USB hub/switch (304a) is connected via a USB bus (312) to the host device 310. The control 314 can, for example, be provided by the host device 310 and/or detected based on the connection 312. Those skilled in the art will appreciate that a hub/switch component 304 can be provided as an external component with respect to a controller 306 as shown in FIG. 3A, or a hub/switch component can be effectively integrated with a controller although not shown in FIG. 3A. By way of example, if USB hub/switch functionality is integrated with a controller, the controller can be responsible for serving a specific range of logical addresses, where a USB command can be decoded and forwarded in a USB “daisy chained” configuration similar to that depicted in FIG. 3A. As such, a controller can eventually receive and decode USB commands and respond to transactions that are targeted for its range of logical addresses.

Referring now to FIG. 3B, the access state switching system 300 is depicted in a multi-unit access state in accordance with one embodiment of the invention. In the embodiment depicted in FIG. 3B, the control 314 is effectively provided to disable the hub and/or switch functionality provided by the access state switching system 300. By way of example, control 314 can be provided as a disable port B signal causing the controllers 306 to be effectively presented to a host 312 with multiple points of access. In this situation, the host 312 would effectively see multiple logical units connected to its connection (e.g., on a bus) and would effectively enumerate a logical unit for each one of the controllers 306. In other words, each one of the controllers 306 and non-volatile storage portions 308 are presented as an individual device 311 for access by the host 312. As such, it will be appreciated that the configuration depicted in FIG. 3B is especially useful when parallel access operations are desired (e.g., a kiosk situation where multiple write operations can be performed). The non-volatile storage portions 308 can, for example, include flash memory. As such, the device 311 can effectively represent a flash drive (or flash device) and be used as such by the host 312. It will be appreciated that the non-volatile storage portions 308 can be different from each other. By way of example, the non-volatile storage portion 308a can include more memory than the non-volatile storage portion 308b or vice versa. It should be noted that the hub and/or switch functionality of the access state switching system 300 can be effectively provided by external hub/switch components 304 with respect to the controllers 306, or the hub and/or switch functionality can be effectively integrated with the controllers 306.

FIG. 3C depicts a method 380 for providing access to a device in accordance with one embodiment of the invention. The method 380 can, for example, be performed by a device 300 depicted in FIGS. 3A and 3B. Referring to FIG. 3C, initially, it is determined (382) whether a connection has been made to another device. If it is determined (382) that a connection to another device has been made, it is determined (384) whether to effectively provide a single or a multi-unit access state. If it is determined (384) to effectively provide multiple units for access in the multi-unit access state, a plurality of controllers are presented (386) which can be accessed via multiple access points respectively. It should be noted that each of the controllers can be accessed individually in order to access one or more non-volatile storage portions effectively controlled by the respective controller. As a result, multiple devices are presented and made accessible via multiple access points typically corresponding to multiple logical units respectively. Thereafter, the method 380 can end.

However, if it is determined (384) to provide access in a single unit access state, an access point is presented as a single access point for accessing a plurality of controllers that actually control the plurality of the non-volatile storage portions. In other words, the single access point can effectively forward access command directly and/or indirectly to the plurality of controllers that actually control the non-volatile storage portions. As such, it is determined (390) whether an access command is received at the single access point. If it is determined (390) that an access command is not received at the single access point, it is determined (392) whether the connection has ended. In effect, the method 380 can wait to receive an access command at the single access point (390) or end as a result of the determination (392) that the connection to the other device has ended. If it is determined (390) that an access command has been received at the single access point, it is determined (394) whether to forward the access command to a controller. In this way, the method 380 can effectively process access commands received at the single access point and forward (396) them to a controller, if necessary, until it is determined (392) that the connection to the other device has ended.

FIG. 4A depicts access state switching system 300 in accordance with another embodiment of the invention. The access state switching system 300 includes an external hub and/or switching system 400 in a configuration where an enable hub/switch mode is provided to effectively cause a device 402 to be presented as a single logical unit 404. As a result, the device 402 is made accessible via a single access point 406 effectively provided by the external hub and/or switching system 400 to a host device 410.

In contrast to FIG. 4A, FIG. 4B depicts the external hub and/or switching system 400 in a disable hub/switch mode where multiple devices 311a are effectively presented to a host device 412. As such, the host device 412 is able to access each of the non-volatile storage portion 308 individually via its respective controller 306 to perform various operations on the non-volatile storage portions independently (e.g., including writing of data in parallel).

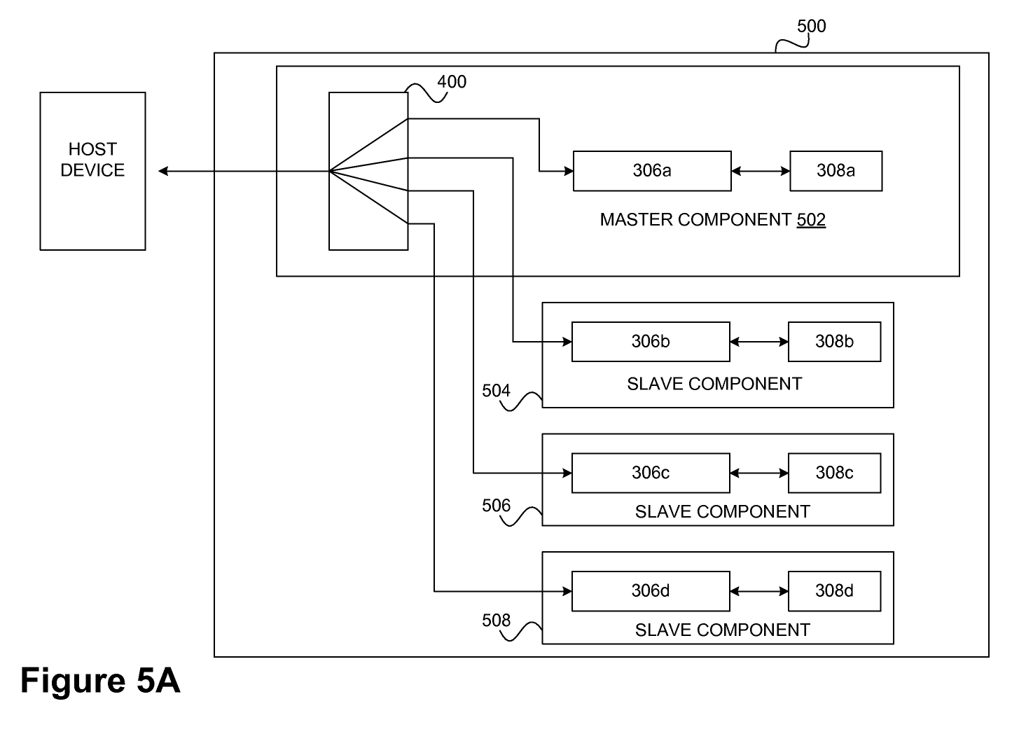

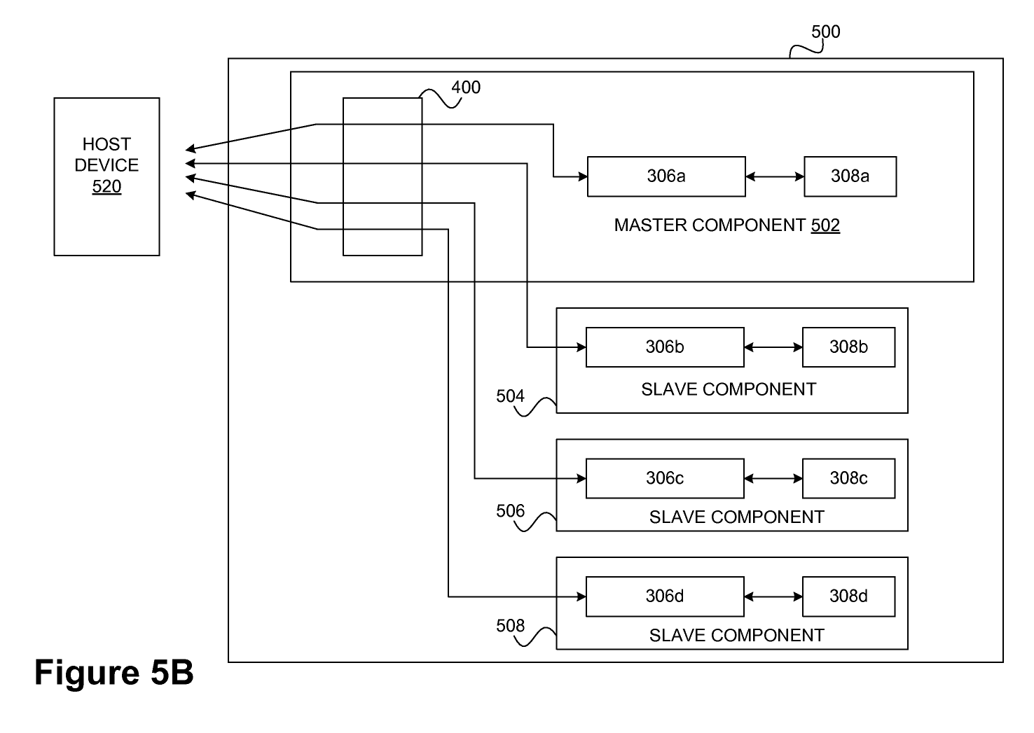

FIG. 5A depicts a device 500 in accordance with another embodiment of the invention. Referring to FIG. 5A, an external hub and/or switch system 400 is provided for the device 500, similar to that depicted in FIG. 4A. However, the external hub and/or switch system 400, controller 306a, and non-volatile storage portion 308a are integrated together to effectively form a master component (or device) 502. As shown in FIG. 5A, the other controllers (306b, 306c and 306d) are connected to the external hub and/or switch system 400 which is integrated into the master component 502. As a result, the slave components (or devices) 504, 506 and 508 are effectively formed with respect to the master component 502.

FIG. 5B depicts a configuration of a master component (or device) 502 and slave components (or devices) 504, 506 and 508 in a multi-unit access state in accordance with one embodiment of the invention. As shown in FIG. 5B, in the multi-unit access state, where each one of the components (or devices) 502, 504, 506 and 508 can be accessed individually by a host device 520 (e.g., a kiosk).

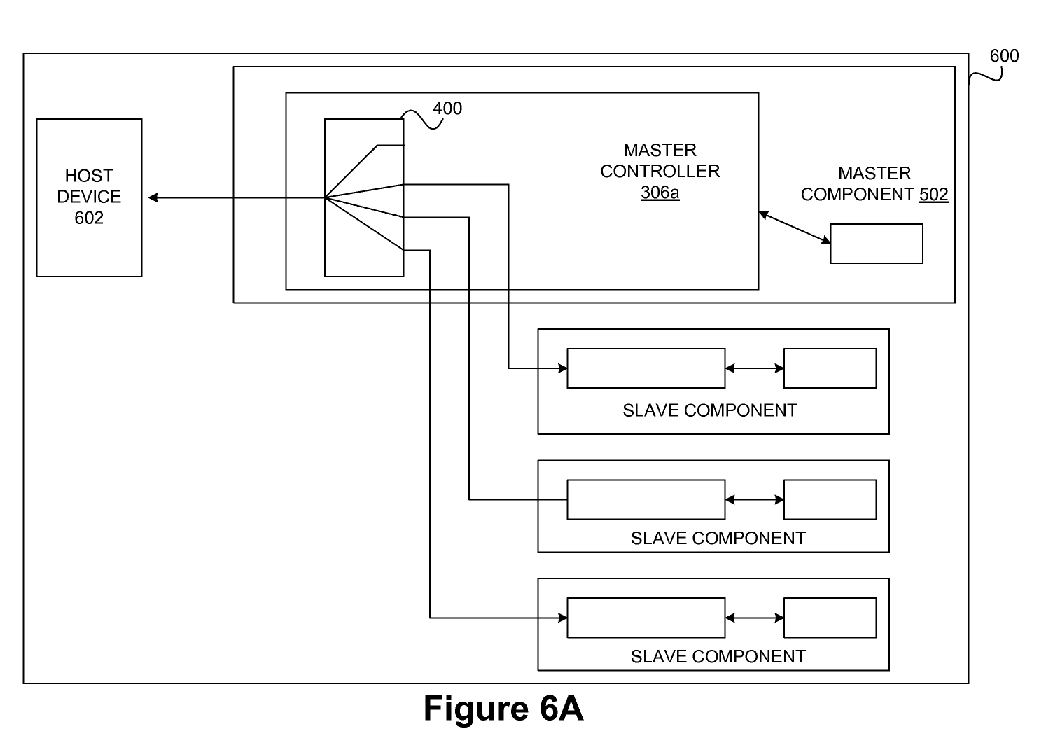

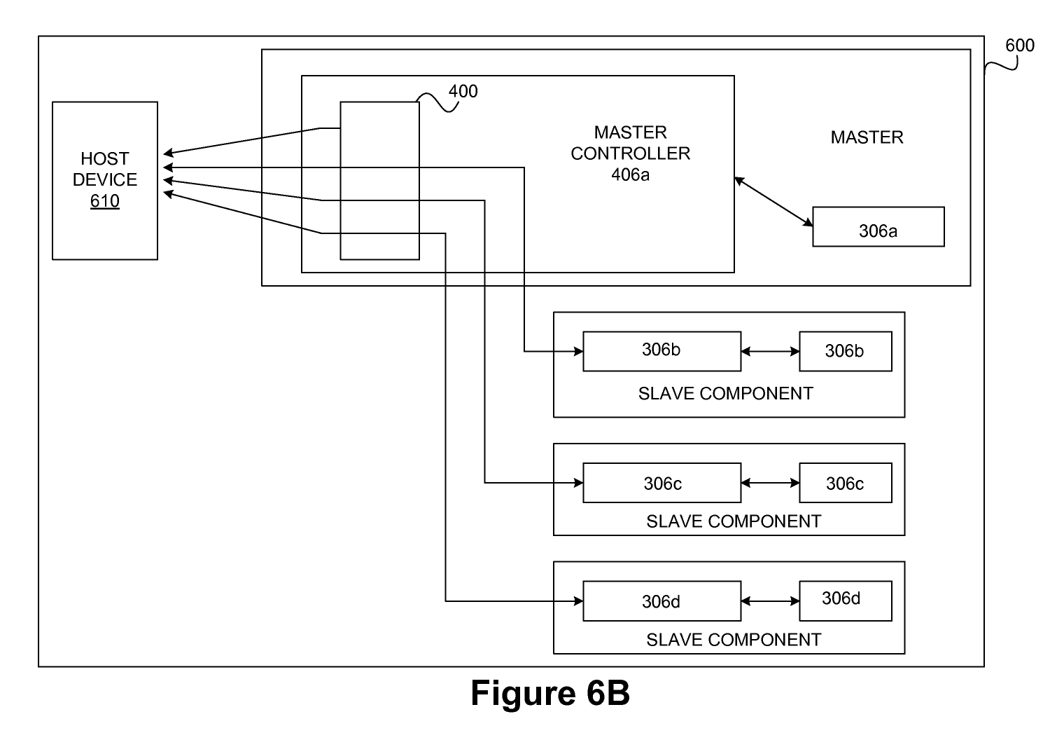

FIG. 6A depicts a device 600 in accordance with yet another embodiment of the invention. More particularly, FIG. 6A depicts a master component 502 and slave components 504, 506 and 508, similar to the embodiment depicted in FIGS. 5A and 5B. However, in the embodiment depicted in FIG. 6A, hub and/or switch system 400 is effectively integrated with the controller 306a of the master component 502. This allows the option of having the master controller 306a manage multiple physical components (or devices) (504, 506 and 508) while presenting a single logical device to a host device 602.

FIG. 6B depicts the configuration of the integrated master controller 406a and the hub and/or switch system 400 in a multi unit access state where each one of the master component (or device) 502 and slave components 504, 506 and 508 can be effectively provided to a host device 610 as individual devices to, among other things, allow the host device 610 to access in parallel is possible via multiple access points (e.g., ports).

FIGS. 7A and 7B depict devices 702 and 704 in accordance with various embodiments of the invention. Referring to FIG. 7A, the device 702 is depicted with two connectors 706 and 708. Each one of the connectors can be used for a particular access state. More specifically, when a connection is made via a connector 706, the device 702 can, for example, be placed in a single unit access state where a plurality of non-volatile storage portions 710 are effectively presented as a single logical unit. On the other hand, when the connection is made via a second connection 708, the device 702 can be effectively placed in a multi-unit access state where each of the plurality of the non-volatile storage portions 710 can be accessed independently and in parallel.

Referring now to FIG. 7B, a device 704 is depicted with a connection 714 which includes a number of individual connectors 714a, 714b, 714c and 714d. The device 704 can, for example, be operable to effectively assume a single unit access state if only the connector 714a is connected to another device. On the other hand, if a connection is made via all of the connectors 714, the device 704 is operable to assume a multi-unit access state where each one of the non-volatile storage portions 710 can be accessed independently and in parallel via one of the connectors 714.

The various aspects, features, embodiments and/or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A device, comprising:
a plurality of non-volatile storage portions including first and second non-volatile storage portions;
a plurality of controllers including first and second controllers for effectively controlling access to said first and second non-volatile storage portions;
wherein said device is operable to effectively provide said first and second non-volatile storage portions in a first access state in which an access point is effectively provided as a single access point for accessing both of said first and second non-volatile storage portions; and
wherein said single access point is operable to effectively forward an access command for accessing any one of said first and second non-volatile storage portions directly and/or indirectly to said first controller and/or second controller so that any one said first and second non-volatile storage portions can be effectively accessed via said first controller and/or second controller by at least one other device that issues said access command via said single access point, thereby allowing said at least one other device to access said first and second non-volatile storage portions as a single logical unit.

2. The device of claim 1,
wherein said first control is operable to effectively control access to said first non-volatile storage portion but not said second non-volatile storage portion, and said second control is operable to effectively control access to said second volatile storage portion but not said first non-volatile storage portion; and
wherein said single access point is further operable to:
directly forward an access command for accessing said first non-volatile storage portion to said first controller, and
directly forward an access command for accessing said second non-volatile storage portion to said second controller.

3. The device of claim 1, wherein said first control is operable to effectively control access to said first non-volatile storage portion but not said second non-volatile storage portion, and said second control is operable to effectively control access to said second volatile storage portion but not said first non-volatile storage portion; and
wherein in said first access state, said single access point is further operable to forward an access command for accessing said second non-volatile storage portion to an access component operable to effectively provide said access command to said second controller, thereby effectively connecting said first and second controller to said single access point.

4. The device of claim 1, wherein said device is further operable to effectively provide said plurality of non-volatile storage portions in a second access state in which said plurality of non-volatile storage portions are effectively presented as two or more logical units to said at least one other device, whereby said first non-volatile storage portion is directly accessible via said first controller and said second non-volatile storage portion is directly accessible via said second controller, thereby allowing said at least one other device to access each one of said plurality of non-volatile storage portions individually via one of said plurality of controllers as a single logical unit of said two or more logical units.

5. The device of claim 4, each of said two or more logical units are operable to be accessed individually and/or in parallel when said plurality of non-volatile storage portions are provided in said second access state.

6. The device of claim 4, wherein said two or more logical units are operable to be accessed individually for parallel write access operations when said plurality of non-volatile storage portions are presented in said second access state, thereby allowing said at least one other device to write to each one of said plurality of non-volatile storage portions in parallel.

7. The device of claim 1, said plurality of non-volatile storage portions are operable to be effectively presented as a single logical unit for read operations when said plurality of non-volatile storage portions are presented in said first access state, thereby allowing said at least one other device to perform read operations using said single access point.

8. The device of claim 1, wherein said device further includes:
an access state switching system operable to effectively switch said device between said first and second access states based on an access-state control.

9. The device of claim 8, wherein said access-state control is effectively obtained and/or generated by said access state switching system as a signal when said device is operatively connected to said at least one other device.

10. The device of claim 9, wherein said device is further operable to receive said access-state control as an access-state control signal from said at least one other device when said at least one other device is operatively connected to said device.

11. The device of claim 9, wherein said device is further operable to receive said access-state control as input which is effectively provided as a configuration option for said device.

12. The device of claim 11, wherein said configuration option can be provided by a user of said device.

13. The device of claim 1, wherein said device further includes:
a first connector operable to provide access in said first access state to at least one other device, wherein said device effectively provides access to said at least one other device in said first access state when said at least one other device is connected via said first connector to said device.

14. The device of claim 13, wherein said device further includes:
a second connector operable to provide access in said second access state to at least yet another device, wherein said device effectively provides access to said at least yet another device in said second access state when said at least yet another device is connected via said second connector to said device.

15. The device of claim 8, wherein said access state switching system includes a hub and/or switch system connected to said plurality of controllers and operable to effectively allow said plurality of controllers to be connected to said single access point in a manner that access commands can be effectively forwarded to each one of said plurality of controllers so that each of said plurality non-volatile memory portions can be accessed via said single access point when said plurality of controllers are presented in said first access state.

16. The device of claim 15, wherein said hub and/or switch system includes a plurality of hub and/or switch components respectively connected to each one of said plurality of controllers, and wherein said plurality of hub and/or components are connected in a daisy chain configuration.

17. The device of claim 15, wherein said hub system and/or switch system includes an external switch and/or hub component provided as an external component with respect to said plurality of controllers, wherein each one of said plurality of controllers are operable to be effectively connected to said external switch and/or hub component when said plurality of non-volatile storage portions are presented in said first access state.

18. The device of claim 15, wherein said hub and/or switch system includes a USB compliant hub switch and/or USB complaint hub.

19. The device of claim 1, wherein one or more of said plurality of non-volatile storage portions includes flash memory.

20. The device of claim 19, wherein said device is and/or includes a USB compliant Flash Drive.

21. The device of claim 15, wherein said hub and/or switch system includes one or more switch and/or hub components effectively integrated with one or more of said plurality of controllers.

22. The device of claim 21, wherein a plurality of said hub and/or switch components are connected together in a daisy chain configuration.

23. The device of claim 15, wherein said hub and/or switch system includes a hub and/or switch component operable to be effectively connected to one of said plurality of controller to form a master controller unit, and wherein said hub and/or switch component is effectively provided as an external component connected to at least one other controller of said plurality of controller which effectively acts as a slave of said master controller unit.

24. The device of claim 15, wherein said hub and/or switch system includes a hub and/or switch component effectively integrated with one of said plurality of controllers to form an integrated master controller unit, and wherein said hub and/or switch component is effectively provided as an external component connected to at least one other controller of said plurality of controller which effectively acts as slave of said integrated master controller unit.

25. A method of providing access to non-volatile storage of a device, said method comprising:
determining whether to effectively present a plurality of non-volatile storage portions of said device as a single logical unit or as multiple logical units for access by another device when said non-volatile storage device is operatively connected to said another device;
effectively presenting said plurality of non-volatile storage portions as a single logical unit for access by said other device when said determining determines to effectively present said plurality of non-volatile storage portions as a single logical unit for access by said other device, thereby allowing said other device to effectively access said plurality of non-volatile storage portions from a single access point; and
effectively presenting said plurality of non-volatile storage portions as multiple logical units for access by said other device when said determining determines to effectively present said plurality of non-volatile storage portions as multiple logical unit for access by said other device, thereby allowing said other device to access said plurality of non-volatile storage portions individually using multiple access points respectively associated with said multiple logical units.

26. A non-volatile storage device including a plurality of non-volatile storage portions, wherein said non-volatile storage device is operable to:
determine whether to effectively present said plurality of non-volatile storage portions as a single logical unit or as multiple logical units for access by another device when said non-volatile storage device and said other device are operatively connected together;
effectively present said plurality of non-volatile storage portions as a single logical unit for access by said other device when said determining determines to effectively present said plurality of non-volatile storage portions as a single logical unit for access by said other device, thereby allowing said other device to effectively access said plurality of non-volatile storage portions as a single logical unit; and
effectively present said plurality of non-volatile storage portions as multiple logical units for access by said other device when said determining determines to effectively present said plurality of non-volatile storage portions as multiple logical unit for access by said other device, thereby allowing said other device to access each of said plurality of non-volatile storage portions individually using each one of said multiple logical units respectively.
